(19) United States
(12) Patent Application Publication
(10) Pub. No.: US 2007/0171785 A1
(43) Pub. Date: Jul. 26, 2007

(54) Optical reader/writer with dedicated focus tracking beam

(75) Inventors: Alexander Marc Van Der Lee, Eindhoven (NL); Christopher Busch, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,274

(22) PCT Filed: Apr. 22, 2005
(86) PCT No.: PCT/IB05/51324

§ 371 Date: Oct. 25, 2006

(30) Foreign Application Priority Data
Apr. 30, 2004 (EP) 04300251.8

(51) Int. Cl. G11B 7/00

(52) U.S. Cl. 369/44.37; 369/112.05

(57) ABSTRACT

The present invention relates to an optical reader for a two dimensional storage disc, comprising means (21, 22, 14, 15) for generating a plurality of laser beams and projecting said beams onto a rotating disc, means (24, 25, 26) for detecting the beams after being diffracted by the disc, and means (24, 27, 28) for determining a focus error signal (29) based on one of said plurality of beams. The plurality of beams comprises an array of beams having a first polarization, and a dedicated central focus tracking beam having a second polarization, orthogonal to the first polarization. The beams may be generated by a polarization dependent diffraction element. Or a beam having one polarization may be diffracted into a plurality of beams and recombined with a beam having another polarization.

### FIELD OF THE INVENTION

The present invention relates to an optical reader/writer for a two dimensional storage disc, comprising means for generating a plurality of laser beams and projecting said beams onto a rotating disc, means for detecting the beams after being diffracted by the disc, and means for determining a focus error signal based on one of the plurality of beams.

### BACKGROUND OF THE INVENTION

Conventionally, optical storage is performed in one dimension, i.e. a track of consecutive bits is written onto the disc (e.g. CD, DVD). Recently, the concept of two dimensional optical storage has been introduced. The format of a 2D disc is based on a broad spiral, consisting of a number of parallel bit rows. Parallel read out is realized using a single laser beam which passes through a diffraction grating producing an array of spots scanning the full width of the broad spiral. Such a system is disclosed in “Two-Dimensional Optical Storage”, by Wim M. J. Coene, OSA Topical Meetings on Optical Data Storage, May 11-14, 2003, Technical Digest, pp 90-92.

For focus tracking of the laser, a focus error signal is generated using conventional methods (e.g. Foucault, astigmatic, spot size) based on the central spot of the array. However, the small separation between spots (in the order of micrometers) causes the spots to overlap very quickly when out of focus. In the overlap region the intensity profile is highly distorted because of interference from adjacent spots, which disturbs the focus signal. As a result, the capture range, or focus S-curve length, is significantly reduced. While a conventional one dimensional optical reader (e.g. a CD ROM drive) has a capture range of around 2-5 micrometers, a two dimensional reader may have a capture range less than one micrometer. The problem is also present during writing of a disc.

### SUMMARY OF THE INVENTION

It is an object of the present invention to overcome this problem, and to provide a two dimensional optical reader/writer with improved focus tracking.

It is a further object to provide a two dimensional optical reader/writer with improved capture range.

These and other objects are achieved by an optical reader/writer of the kind mentioned in the introduction, wherein said plurality of beams comprises an array of beams having a first polarization, and a dedicated focus tracking beam having a second polarization, orthogonal to said first polarization, and wherein said focus error signal is based on said focus tracking beam.

According to the invention, beams having one polarization are used for the actual accessing of the data on the disc, while a beam having a second polarization is used for focus tracking. The focus tracking can then be based on one single beam, without interference from adjacent beams.

The focus tracking beam may coincide with one of the beams, preferably the central beam, of the beam array. This ensures that the reflected beam used for focus tracking is reflected in a spot that is actually used during read-out/writing. The likelihood of achieving acceptable focus in most of the array beams (i.e. even if they are mutually unaligned) is increased by using the central beam.

The means for detecting the beams preferably comprises a beam separator for separating the dedicated focus tracking beam from the array of beams. This provides for separation of the dedicated focus tracking beam from the read-out/writing beams, and thus facilitates application of tracking methods, such as the Foucault method. In the case of reading, the read-out beams must also be separated in order to enable processing of the high frequent data, while in the case of writing, it may be enough to distinguish the focus beam.

The beam separator can comprise a polarizing beam splitter, arranged to reflect the array of read-out beams in one direction, and the dedicated focus tracking beam in a different direction. Such beam splitters are known in the art.

According to one embodiment of the invention, the laser generating means comprises a laser for generating a laser beam, and a diffraction element arranged in the optical path of the beam, the diffraction element being adapted to diffract light polarized in one direction, while transmitting light polarized in another direction, orthogonal to the first direction. The diffraction element will thus generate an array of beams having a first polarization, and a single beam having a different (and orthogonal) polarization. By adjusting the orientation of the diffraction element in relation to any polarization of the incident laser beam, the distribution of power between the focus beam and beam array can be controlled.

Such a diffraction element can be realized by a binary grating made of a birefrigent material, where the grating depth is chosen such that for light of one polarization the desired diffraction is achieved, while for light of orthogonal polarization no diffraction is present. This can be accomplished by letting the grating depth satisfy the equations:
(nₑ−1)h=1λ
(nₒ−1)h=φₛₜₑₚ/2π+mλ

where λ is the wave length of the laser, nₒ is the ordinary index of refraction, nₑ is the extraordinary index of refraction, φₛₜₑₚ is the phase step of the binary grating required to provide the desired diffraction, and 1 and m are integers. Such a grating is not difficult to manufacture.

According to a different embodiment, the laser generating means comprises means for generating a first laser beam with said first polarization and a second laser beam with said second polarization, a diffraction element arranged in the optical path of the first beam for diffracting said first beam into said array of beams, and a combiner arranged to recombine said second beam with said beam array. This embodiment does not require a polarization sensitive diffraction element as mentioned above, but instead merges laser beams having different polarization together after one of them has been diffracted into an array of beams.

The means for generating a first and a second polarized laser beam can comprise a laser for generating a laser beam and a polarizing beam splitter arranged in the optical path of the beam. By orienting the beam splitter suitably in relation to the polarization of the laser beam, two laser beams having orthogonal polarization and essentially equal power can be obtained.

### BRIEF DESCRIPTION OF THE DRAWINGS

This and other aspects of the present invention will now be described in more detail, with reference to the appended drawings showing a currently preferred embodiment of the invention.

FIG. 1 shows the layout of two dimensional storage on an optical disc.

FIG. 2 shows parallel read-out of the disc in FIG. 1 according to prior art.

FIG. 3 shows schematically a set-up for an optical reader according to a first embodiment of the present invention.

FIG. 4 shows schematically a set-up for an optical reader according to a second embodiment of the present invention.

### DETAILED DESCRIPTION OF THE INVENTION

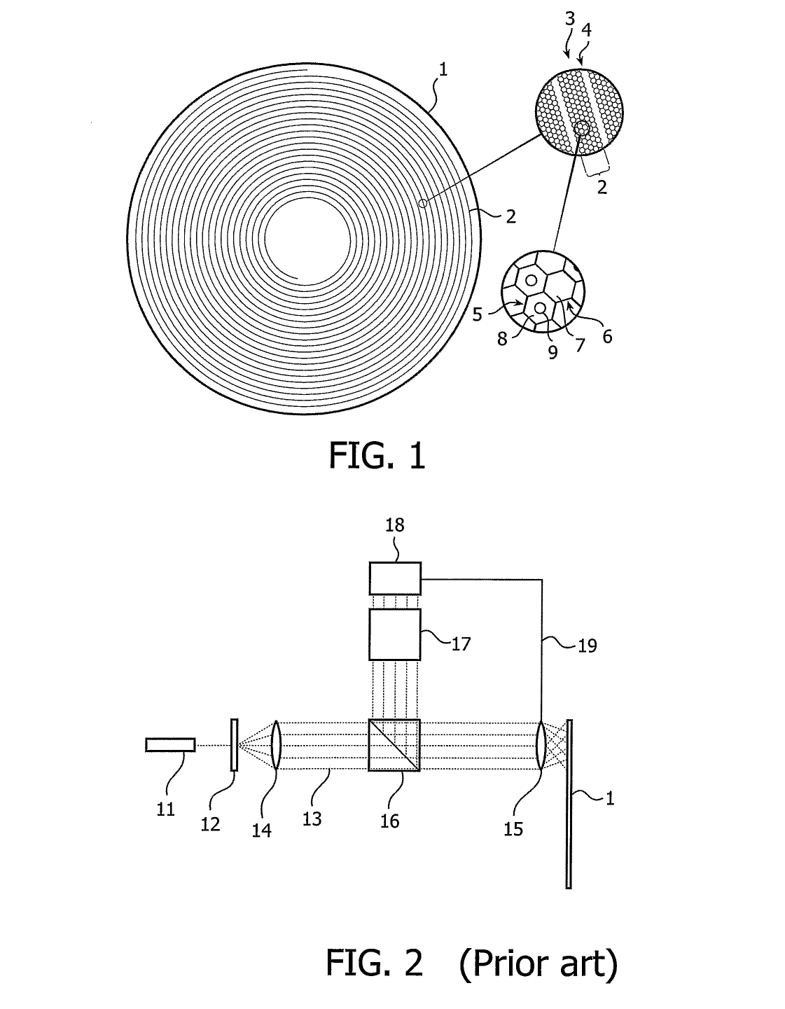

The principles of two dimensional storage on an optical disc 1 is illustrated in FIG. 1. The information is stored in a broad spiral 2, comprising a number of parallel bit-rows 3, here five rows, and a guard band 4. In the example in FIG. 1, the bit-rows 3 are aligned with each other in the radial direction to form a hexagonal lattice of bits. This means that each bit 5, 6 is associated with a physical hexagonal bit-cell 7, 8. Typically, the bit-cell 7 of a bit with value zero has a uniformly flat area, while a bit-cell 8 for a bit with value one has a hole 9 centrally in the hexagonal area. The size of such a hole 9 is preferably comparable with or smaller than half of the bit-cell area, in order to eliminate signal folding, i.e. a cluster of zeroes and a cluster of ones would both result in a perfect mirror.

FIG. 2 shows how parallel read-out from the disc in FIG. 1 is realized conventionally, using a laser beam 11 which passes through a diffraction grating 12 which produces an array of beams 13 which are focused onto the disc 1 by a collimator lens 14 and an objective lens 15, to form an array of spots across the entire width of the spiral 2. Each beam 13 is reflected and diffracted by the disc 1, and is then reflected by a beam splitter 16 and detected by a multi-partitioned photo-detector 17 which generates a number of high frequency waveforms used as input for 2D signal processing, performed in a processor 18. The processor 18 also provides a focus tracking signal 19 to the optical system 15, by calculating a focus error signal based on the central spot. Such a system is described in “Two-Dimensional Optical Storage”, by Wim M. J. Coene, OSA Topical Meetings on Optical Data Storage, May 11-14, 2003, Technical Digest, pp 90-92, herewith incorporated by reference.

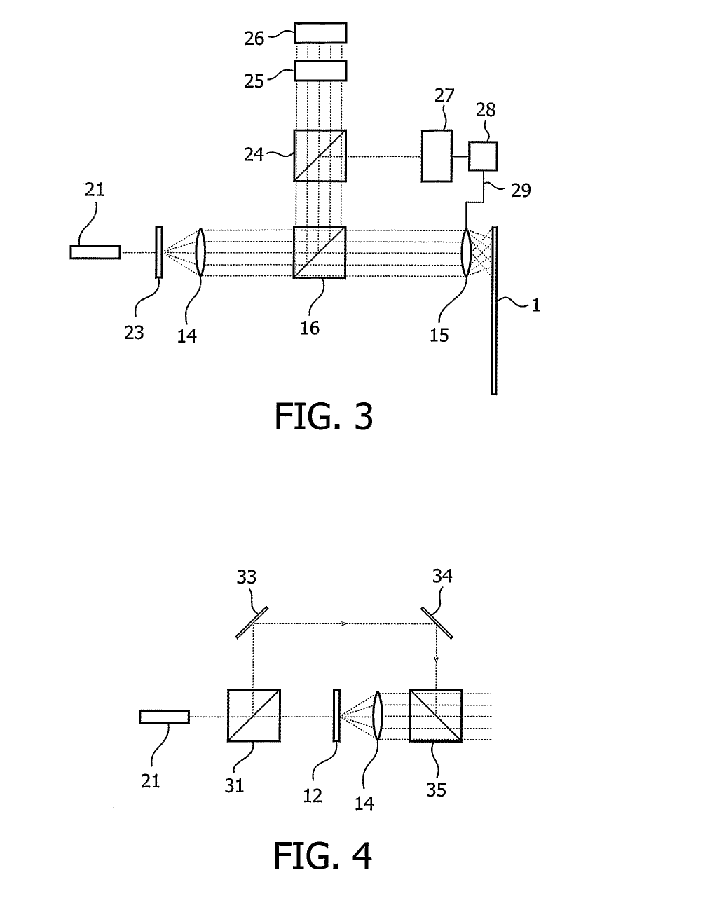

A first embodiment of the invention is shown in FIG. 3, where elements corresponding to elements in FIG. 2 are denoted with identical reference numerals. In this embodiment, a diffraction element 23, here a binary grating, is arranged in the optical path of a beam from a laser 21. The grating 23 is adapted to act as a diffraction element for light of a first polarization, while being transparent for a second polarization, orthogonal to the first.

This can be accomplished with a binary grating made of a birefringent material, where the grating depth of the grating is such that for light of one polarization the required phase depth is achieved and for light of orthogonal polarization the phase depth is a multiple of 2π. Expressed in equations, this corresponds to:
(nₑ−1)h=1λ
(nₒ−1)h=φₛₜₑₚ/2π+mλ

where λ is the wave length of the laser, nₒ is the ordinary index of refraction, nₑ is the extraordinary index of refraction, φₛₜₑₚ is the phase step of the binary grating required to provide the desired diffraction, and 1 and m are integers.

These equations determine the height step and refractive indices required in the grating. Solving for nₑ we get

$${n}_{e} = 1 + \frac{l}{{ϕ}_{step} / 2 π} ( {n}_{o} - 1 ) .$$

Taking a realistic value of φₛₜₑₚ/2π≈0.4 and nₒ≈1.5 we get for l=m=1 an extraordinary index of refraction of nₑ=1.36 and step height h=1.13 μ. A grating with these characteristics is not difficult to realize with known technology.

The diffraction element 23 thus creates an array of laser beams polarized in one direction, and one single laser beam polarized in an orthogonal direction. The power of the focus beam in relation to the beam array is determined by the orientation of the diffraction element to any polarization of the incident beam. As the array and the single beam (focus beam) both stem from the same laser, they will coincide, and preferably the focus beam will coincide with the central beam of the array.

The beam array and the dedicated focus tracking beam are then focused onto the disc and reflected in a similar way as was described above with reference to FIG. 2. The reflected beams are then directed into a beam separator 24, adapted to separate the reflected beam array, comprising the high frequency read-out data, from the reflected focus beam. This separation is here accomplished by a polarizing beam splitter, which directs light of one polarization in one direction, and light of an orthogonal polarization in a different direction.

The high frequent read-out data is directed to an optical multi-partitioned photo-detector 25 which generates a number of high frequency waveforms used as input for 2D signal processing in a processor 26, essentially in the same way as described above with reference to FIG. 2. The focus beam is instead directed to another photo-detector 27 and another processor 28, which generates a focus tracking signal 29. This signal is used to track the optical system 15, as described above.

A second embodiment of the invention is shown in FIG. 4. In this case, the beam from the laser 21 is first split in two by a polarizing beam splitter 31, resulting in two laser beams with orthogonal polarization. It should be noted that the first laser beam coming from the laser 21 typically is polarized, or at least almost polarized. By adjusting the orientation of the beam splitter in relation to the polarization of the first laser beam, the power of the beams can be controlled. One of the polarized beams is directed into a standard diffraction element 12, e.g. a binary grating like the one in FIG. 2, and is diffracted into an array of beams. The other polarized beam is guided by reflecting surfaces 33, 34 to a transmissive mirror 35 (i.e. an inverted beam splitter), where it is merged with the array. The resulting beam combination is equivalent to the beams generated by the polarization sensitive grating 22 in FIG. 3.

The person skilled in the art realizes that the present invention by no means is limited to the preferred embodiments described above. On the contrary, many modifications and variations are possible within the scope of the appended claims, and different combinations of optical elements may be used to achieve the same or similar result. For example, one or several polarization sensitive gratings may be used instead of the polarizing beam splitter 24. Also, although the invention has been described with reference to an optical reader, the invention is equally applicable to an optical writer, where the same focus tracking is required.

Any reference sign in a claim should not be construed as limiting the claim. Use of the verb “to comprise” and its conjugations does not exclude the presence of elements or steps other than those stated in a claim. Use of the article “a” or “an” preceding an element or step does not exclude the presence of a plurality of such elements or steps.

1. An optical reader/writer for a two dimensional storage disc, comprising:
means (21, 23, 14, 15; 21, 31, 32, 33, 34, 14, 35, 15) for generating a plurality of laser beams and projecting said beams onto a rotating disc,
means (24, 25, 26) for detecting the beams after being diffracted by the disc, and
means (24, 27, 28) for determining a focus error signal (29) based on one of said plurality of beams, characterized in that
said plurality of beams comprises an array of beams having a first polarization, and a dedicated focus tracking beam having a second polarization, orthogonal to said first polarization, and
wherein said focus error signal (29) is based on said focus tracking beam.

2. An optical reader/writer according to claim 1, wherein said focus tracking beam coincides with one of the beams, preferably the central beam, of the beam array.

3. An optical reader/writer according to claim 1, wherein said means for detecting the beams comprises a beam separator (24) for separating the dedicated focus tracking beam from the array of beams.

4. An optical reader/writer according to claim 3, wherein said beam separator comprises a polarizing beam splitter (24), arranged to reflect the array of read-out beams in one direction, and the dedicated focus tacking beam in a different direction.

5. An optical reader/writer according to claim 1, wherein said laser generating means comprises a laser (21) for generating an unpolarized laser beam, and a diffraction element (23) arranged in the optical path of the beam, said diffraction element being adapted to diffract light having said first polarization while transmitting light having said second polarization.

6. An optical reader/writer according to claim 5, wherein said diffraction element is a binary grating made of a birefrigent material.

7. An optical reader/writer according to claim 6, wherein said binary grating has a grating depth that satisfies:
(nₑ−1)h=1λ
(nₒ−1)h=φₛₜₑₚ/2π+mλ
where λ is the wave length of the laser, nₒ is the ordinary index of refraction, n^{e} is the extraordinary index of refraction, φₛₜₑₚ is the phase step of the binary grating required to provide the desired diffraction, and 1 and m are integers.

8. An optical reader/writer according to claim 1, wherein said laser generating means comprises means (21, 31) for generating a first laser beam with said first polarization and a second laser beam with said second polarization, a diffraction element (12) arranged in the optical path of the first beam for diffracting said first beam into said array of beams, and a combiner (35) arranged to recombine said second beam with said beam array.

9. An optical reader/writer according to claim 8, wherein said means (21, 31) for generating a first and a second polarized laser beam comprises a laser (21) for generating a laser beam and a polarizing beam splitter (31) arranged in the optical path of the beam.
